(19) United States
(12) Patent Application Publication
(10) Pub. No.: US 2012/0206371 A1
(43) Pub. Date: Aug. 16, 2012

(54) Direction Sensation Haptic Motion

(75) Inventors: Seppo T. Turunen, Tampere (FI); Hannu V. Vilpponen, Jarvenpaa (FI); Anssi I. Vanska, Helsinski (FI); Jukka M.K. Raisamo, Tampere (FI); Roope S. Raisamo, Tampere (FI); Jussi E. Rantala, Tampere (FI)

(73) Assignee: Nokia Corporation

(21) Appl. No.: 13/024,648

(22) Filed: Feb. 10, 2011

(51) Int. Cl. G08B 6/00; G06F 3/041

(52) U.S. Cl. 345/173

(57) ABSTRACT

An apparatus including a housing; and a haptic system. The haptic system includes a plurality of haptic devices. The haptic system is configured to generate a linear motion sensation in a direction at an exterior side of the housing to a user touching the housing. The haptic devices do not move in the direction during the generated linear motion sensation.

### BACKGROUND

1. Technical Field

The exemplary and non-limiting embodiments relate generally to haptics and, more particularly, to haptics to provide a linear motion sensation.

2. Brief Description of Prior Developments

Navigational guidance applications are known for hand-held devices, such as mobile phones. The applications provide visual guidance information on a display, and perhaps audio guidance information. Hand-held devices which can provide haptic feedback to a user are also known.

### SUMMARY

The following summary is merely intended to be exemplary. The summary is not intended to limit the scope of the claims.

In accordance with one aspect, an apparatus is provided including a housing; and a haptic system. The haptic system includes a plurality of haptic devices. The haptic system is configured to generate a linear motion sensation in a direction at an exterior side of the housing to a user touching the housing. The haptic devices do not move in the direction during the generated linear motion sensation.

In accordance with another aspect, a method comprises sending signals to a plurality of separately movable haptic devices which are located at an exterior side of a housing; and actuating the haptic devices based upon the signals to generate a linear motion sensation to a user on the exterior side of the housing in a direction, where the haptic devices do not move in the direction to generate the linear motion sensation.

In accordance with another aspect, a program storage device readable by a machine, tangibly embodying a program of instructions executable by the machine for performing operations is provided. The operations comprise sending signals to a plurality of separately movable haptic devices which are located at an exterior side of a housing; and actuating the haptic devices based upon the signals to generate a linear motion sensation to a user on the exterior side of the housing in a direction, where the haptic devices do not move in the direction to generate the linear motion sensation.

### BRIEF DESCRIPTION OF THE DRAWINGS

The foregoing aspects and other features are explained in the following description, taken in connection with the accompanying drawings, wherein:

FIG. 1 is a perspective view of an example embodiment;

FIG. 2 is a perspective view of a rear side of the apparatus shown in FIG. 1;

FIG. 3 is a schematic perspective view of haptic components at the rear side of the apparatus shown in FIG. 2;

FIG. 4 is a schematic cross sectional view of one of the haptic devices shown in FIG. 3;

FIG. 5 is a diagram illustrating the pattern of top members of the haptic devices shown in FIG. 3;

FIG. 6 shows three actuator driving patterns that create a sensation of linear movement;

FIG. 7 is a diagram illustrating a series of signals used to generate one of the patterns shown in FIG. 6;

FIG. 8 is another series of three actuator driving patterns that create a sensation of linear movement similar to FIG. 6;

FIG. 9 is a diagram illustrating one of the electrical signals used to generate one of the patterns shown in FIG. 8;

FIG. 10 is a diagram illustrating a concept of using electrotactile feedback;

FIG. 11A-11F illustrate examples of how menu operations could be supported with features of an example embodiment;

FIG. 12 is a perspective view of a rear side of an apparatus illustrating another example embodiment;

FIG. 13 is a rear side view schematically illustrating another example embodiment;

FIG. 14 is a cross sectional view showing one of the actuators shown in FIG. 13; and

FIG. 15 is a diagram illustrating some steps of an example method.

### DETAILED DESCRIPTION OF EMBODIMENTS

Although features will be described with reference to the example embodiments shown in the drawings, it should be understood that the features may be embodied in many alternate forms of embodiments. In addition, any suitable size, shape or type of elements or materials could be used.

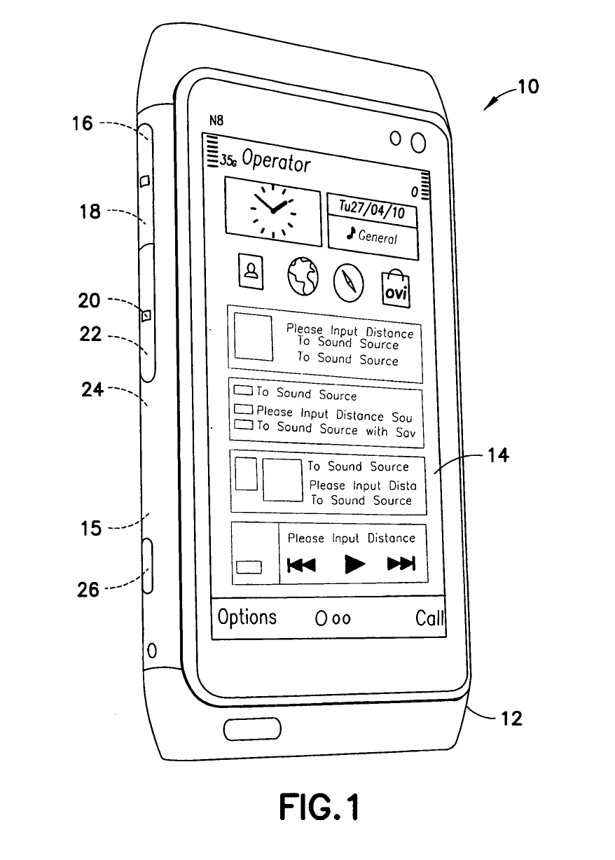

Referring to FIG. 1, there is shown a perspective view of an apparatus 10 according to an example embodiment. In this example the apparatus 10 is a hand-held portable apparatus comprising various features including a telephone application, Internet browser application, camera application, video recorder application, music player and recorder application, email application, navigation application, gaming application, and/or any other suitable electronic device application. The apparatus may be any suitable portable electronic device, such as a mobile phone, computer, laptop, PDA, etc.

The apparatus 10, in this example embodiment, comprises a housing 12, a touch screen 14 which functions as both a display and a user input, and electronic circuitry including a printed wiring board 15 having at least some of the electronic circuitry thereon. The electronic circuitry can include, for example, a receiver 16, a transmitter 18, and a controller 20. The controller 20 may include at least one processor 22, at least one memory 24, and software. A rechargeable battery 26 is also provided.

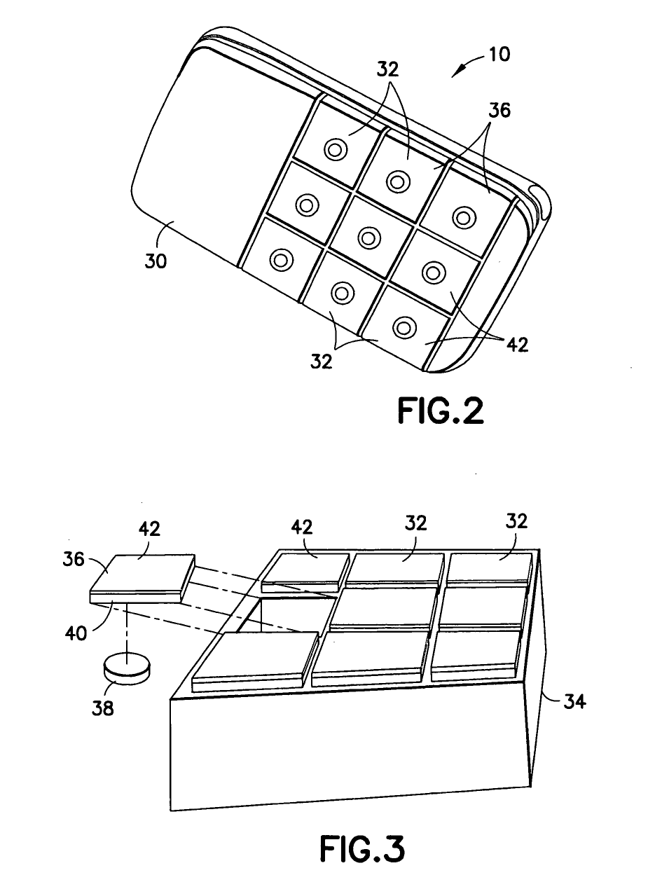

Referring also to FIG. 2, a rear side 30 of the apparatus 10 is shown. The rear side 30 could also comprise a camera (not shown). The rear side 30 comprises a plurality of haptic devices 32. In this example embodiment there are nine of the haptic devices 32 arranged in an array as a matrix of three columns and three rows. However, in alternate example embodiments any suitable number of haptic devices could be provided (such as at least three) and they could be arranged in any suitable array relative to each other. In this example embodiment the haptic devices function as part of the cover or housing at the rear side 30, and occupy a majority of the rear side. However, in alternate embodiments they might not occupy a majority of the side, and could be located on front, top, bottom and/or lateral sides of the apparatus in addition to, or as an alternative to, the rear side location.

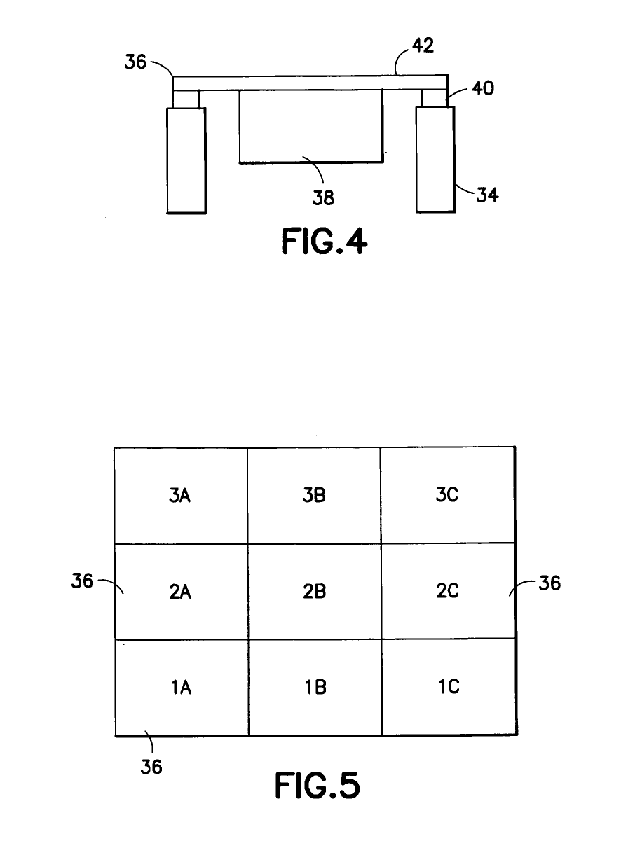

Referring also to FIGS. 3-4, the rear side of the housing forms a chassis 34 for mounting the haptic devices 32. In this example embodiment each haptic device 32 comprises a top member 36, an actuator 38 and an elastic chassis 40. The actuator 38 comprises a motion device, such as a vibra or vibration actuator for example. The actuator could have rotary or linear vibration. In an alternate embodiment any suitable type of touch feedback device could be provided such as by changing temperature, vibration, tapping and/or electrical stimulation for example. In this embodiment each one of the actuators 38 is attached to a bottom side of a separate one of the top members 36. The actuators are connected to the controller 20 such that the actuators 38 may be separately actuated by the controller 20.

The top members 36 may be comprised of plastic with an exterior side 42 intended to be directly touched by the user's skin; such as a hand. In this embodiment each top member 36 has a separate one of the elastic chassis 40. Each elastic chassis 40 may be comprised of resilient polymer or rubber material. The elastic chassis 40 allow their respective top member 36 to move relative to the chassis 34 substantially isolated from the adjacent top members 36. Thus, each haptic device 32 is independently and separately actuatable, and may provide haptic sensation at their respective top member 36 physically isolated from adjacent top members; so that when one top member is moved, an adjacent top members is substantially not moved by that motion. Thus, the two chassis 34, 40 provide motion isolation between the top members 36; the top members 36 being spaced from one another by gaps.

Referring also to FIGS. 5-7, FIG. 5 schematically illustrates the nine top members 36 shown in FIGS. 2 and 3. The nine top members 36 are labeled by their row and column 1A-3C for reference purposes. Using multiple tactile actuators resting against a user's hand it is possible to indicate directions and artificial simulated directional movement. This makes it possible to give route guidance without visual or audible signals. It also makes it possible to navigate in lists and menu structures fully or partially without visual clues. A sensation of sliding, smooth movement along the skin may be created by driving three or more of the haptic devices 32 with a suitable sequential signal pattern.

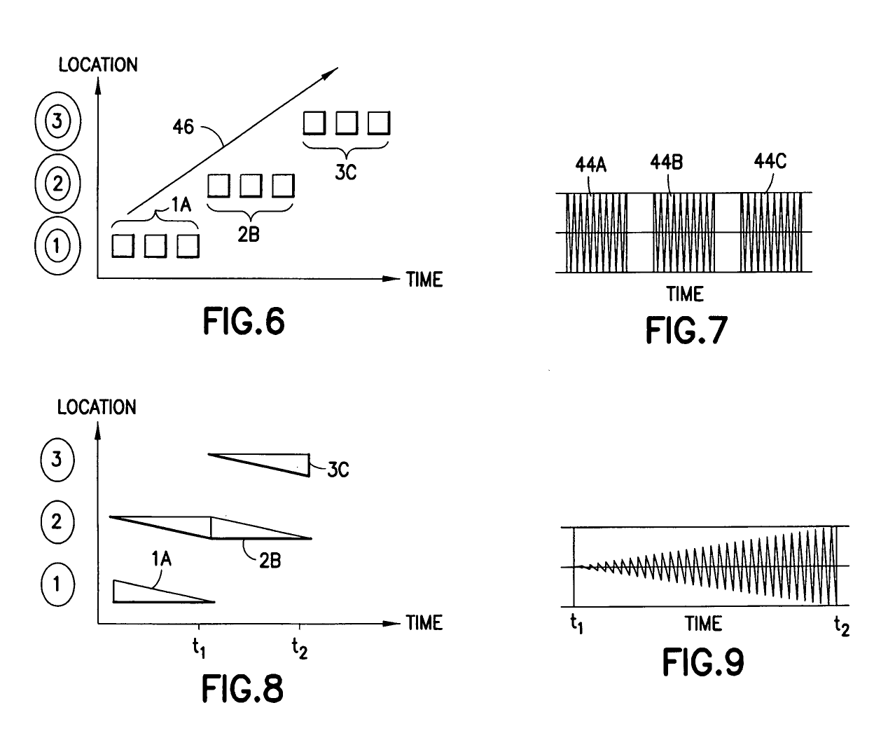

An example of one such signal pattern is shown in FIG. 6. In this example 1A, 2B and 3C may be sequentially actuated over time. FIG. 7 illustrates three signals 44A, 44B, 44C sent to the actuators 38 of the haptic devices to move the top members 1A, 2B and 3C as illustrated in FIG. 6. The resulting sensation to the user holding the apparatus 10 is a sliding, smooth movement as illustrated by arrow 46. Thus, the haptic system is configured to generate a linear motion sensation in a direction (46) at an exterior side of the housing to a user touching the housing, where the haptic devices do not move in the same direction during the generated linear motion sensation.

Referring also to FIG. 8 another example is shown where amplitude of movement of the haptic devices is also varied to generate a linear motion sensation in a direction at an exterior side of the housing to a user touching the housing, where the haptic devices do not move in the same direction during the generated linear motion sensation. The actuator for 1A is initially actuated at a high amplitude and moves less until time t₁ where it stops. The actuator for 2B increases until time t₁ where it reaches its maximum and then reduces to zero at t₂. The actuator for 3C increases amplitude of movement from time t₁ to t₂ where it then stops. FIG. 9 illustrates the signal used for 3C in FIG. 8. This can provide the sensation 46 shown in FIG. 46.

Navigation and route guidance applications use visual and audible user interface. Various user interface operations related to list and menu manipulation use mainly visual feedback, except that sometimes tactile confirmations to user actions are given post factum. An example embodiment could use the directional haptic sensation in navigation and route guidance applications in addition to, or as an alternative to, the visual and audible user interface. It is difficult or unacceptable for a user of mobile equipment to view a display or to listen to sound alerts or audio guidance when walking or driving. Features of the example embodiment described above could be used to provide guidance without the user having to use audio or visual guidance from the apparatus.

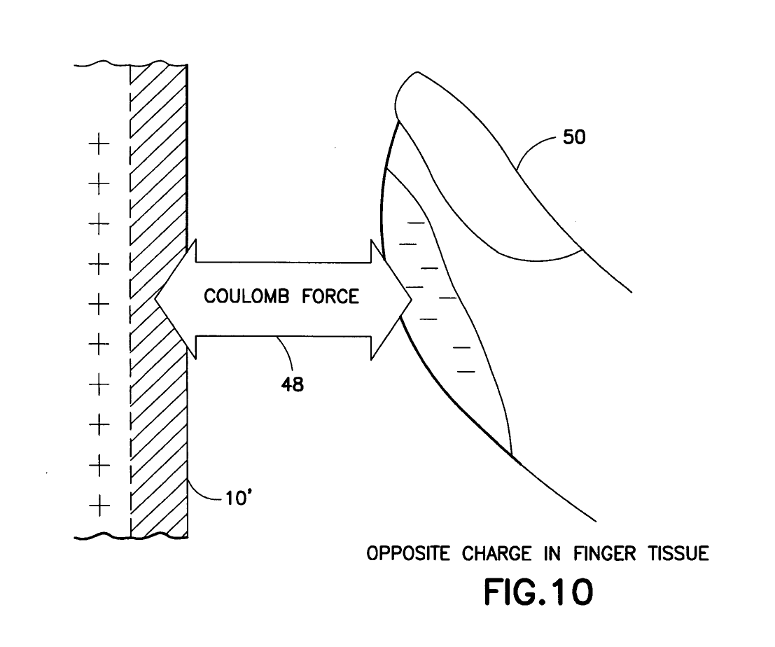

The example of FIG. 3 shows how actuators 38 may be attached to a plastic hat 36 that forms an element of the outer surface of a device. The element is suspended with a flexible gasket 40 to allow it to move with respect to the device body. The body 34, thus, remains more or less stationary. Actuators with an internal counterbalancing mass could be used. Examples are eccentric rotating mass (ERM) actuators and linear resonant actuators (LRA). Actuators without an internal counterbalancing mass could be used. Examples are single and multilayer piezoelectric actuators. Electrotactile actuators of the high voltage type could be used such as illustrated in FIG. 10.

FIG. 10 shows a system which can use touchless touch feedback. Implementing a touch feedback for touch devices with even reasonable quality may be difficult in some situations. Current solutions rely on physical movement, which may be a major implementation hurdle in electro-mechanics. A new technology by Senseg of Helsinki, Finland may be used to make the finger itself the moving mass in the feedback mechanism by using coulomb force. It may allow for precise control of the touch experience. The technology enables multi-touch feedback. It is based on a transparent foil that can be integrated on the inner side of the display window. Some key features are touch feedback even without physical contact, and localized tactile sensations. As seen in FIG. 10 coulomb force 48 may be used between the device 10′ and the user's finger 50.

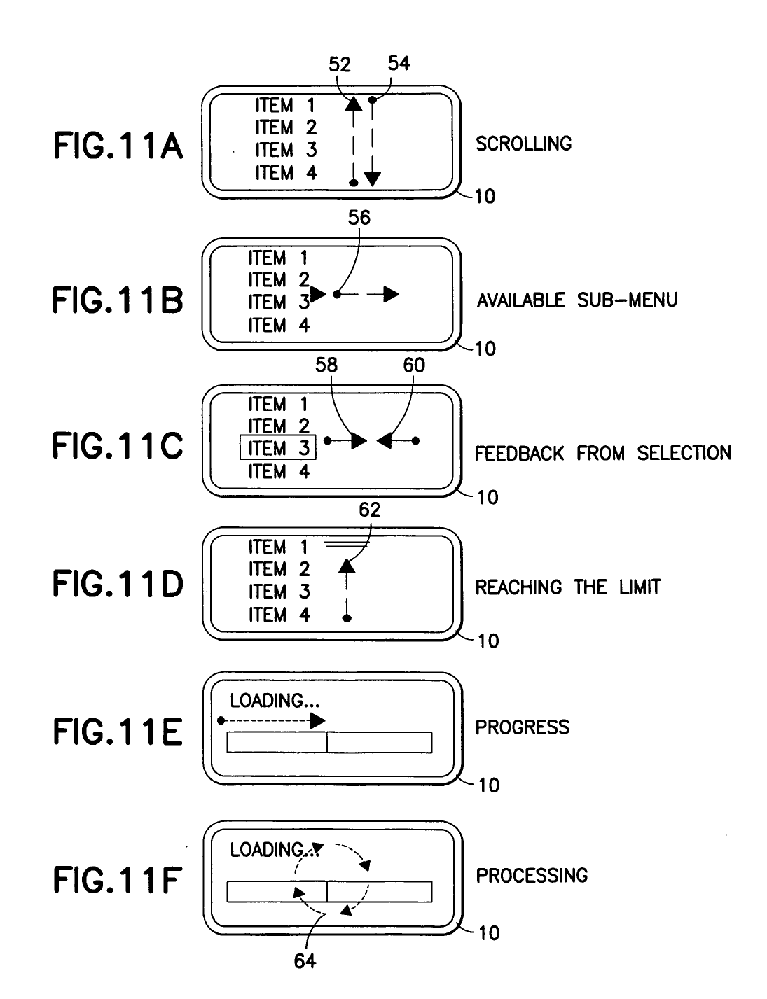

Besides use with navigation and guidance software applications, the directional haptic sensation may be used with other applications; perhaps to supplement visual and/or audio information for example. Referring also to FIGS. 11A-11F, examples of other haptic motion sensations are shown which may be provided for example situations. FIG. 11A illustrates that up scrolling 52 and down scrolling 54 may be signaled. For example 1B, 2B and then 3B (see FIG. 5) could be sequentially moved to provide the up scrolling 52 sensation. 3B, 2B and then 1B (see FIG. 5) could be sequentially moved to provide the down scrolling 54 sensation. FIG. 11B illustrates that a linear haptic sensation could be generated when a sub-menu is available for a displayed item (in this example Item 3) when that item is highlighted. For example 2A, 2B and then 2C could be sequentially moved to provide the directional sensation 56. FIG. 11C illustrates that feedback from a user selection (selection of Item 3 in this example) could be provided such as two opposite motion sensations 58, 60. An example could be 2A and 2C being simultaneously moved and then 2B being subsequently moved. FIG. 11D illustrates that reaching a limit could be signaled by tactile feedback 62, such as moving 1B, then 2B sequentially, and then subsequently moving 3B multiple times. FIG. 11E illustrates that progress of an operation could be signaled (in this case loading of a picture or download) such as by vibrating 2A at a start of the operation, sequentially vibrating 2A and then 2B repeatedly at a middle of an operation, and sequentially vibrating 2A and then 2B and then 3B repeatedly as an end of the operation approaches. FIG. 11F illustrates that a non-straight linear motion may be provided. In this example the linear motion is a circular motion. As an example, 1B could be moved, then 2A could be moved, then 3B could be moved, then 2C could be moved, and the process repeated to generate a circular movement sensation 64 to the user. This could be used to signal processing by the apparatus for example. Different haptic device 32 placements on the housing are possible and different signal driving patterns are possible. For example, to create a sensation of directional movement, three elements arranged into a row can be cyclically activated.

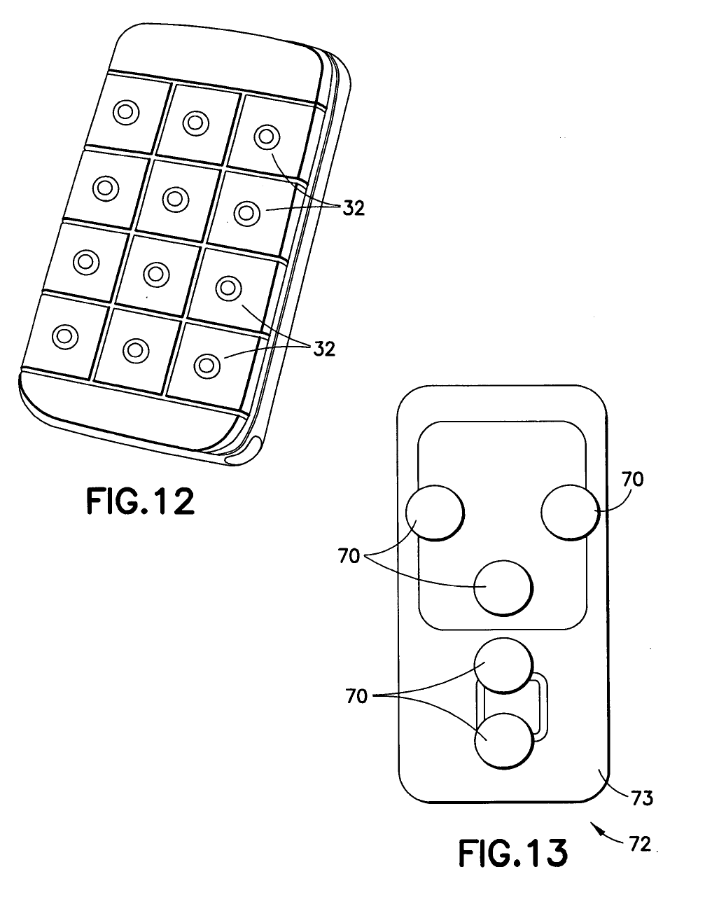

FIG. 12 illustrates an alternate example embodiment where the array of haptic devices comprises a matrix of twelve of the devices at the rear side of the apparatus. Any suitable array could be provided.

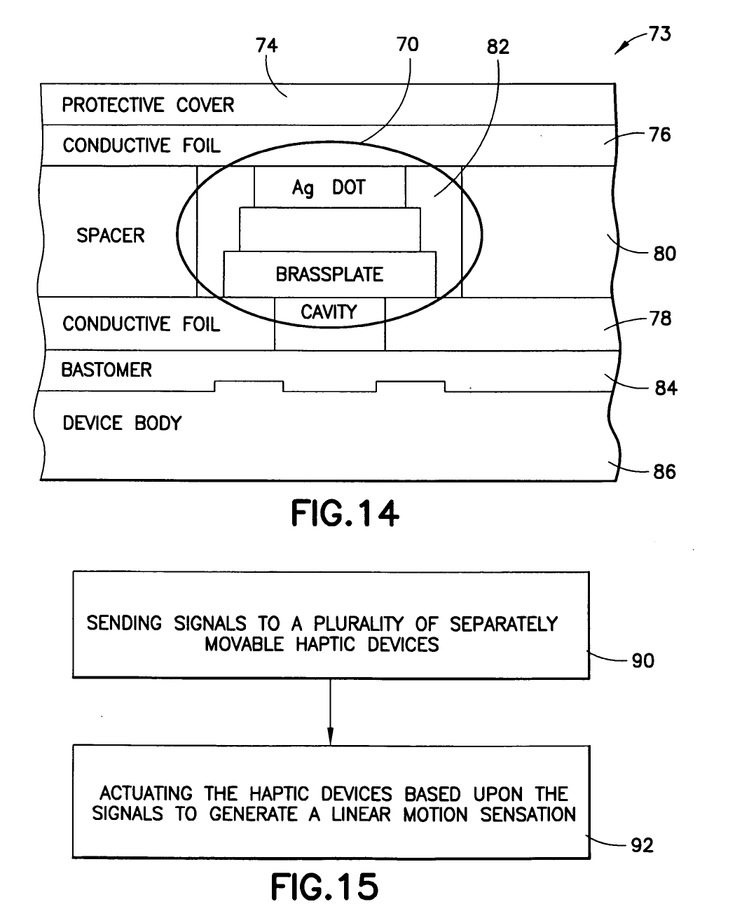

Referring also to FIGS. 13 and 14, as an alternative solution, circular piezoelectric discs 70 could be attached on the outer surface of an apparatus 72 and covered with a thin protective layer 74. The vibration of such a piezoelectric disc 70 could be locally felt by the user. The body of the apparatus 72 could remain essentially stationary because of the small mass of the element. A commercially available piezoelectric disc is capable of producing deflections exceeding 50 um forces exceeding 0.5 N; both of which would be more than sufficient to create a clear tactile sensation. This single layer element could be driven, for example, with a Maxim11835 integrated circuit. In the example shown in FIGS. 13-14, each piezo 70 may be electrically connected to conductive foils 76, 78, and a spacer 80 provided. The piezo 70 is, thus, located in a cavity 82. A resilient elastomer layer 84 may be provided between the piezo actuator 70 and the body 86 of the apparatus 72. This may be provided in a removable back cover 73 with an electrical contact for connection to the other electronics in the apparatus 72.

Examples of use cases that may benefit are: route guidance, menu browsing and scrolling, progress bar simulation, and user-to-user messaging. Features provided by an example embodiment may eliminate the need for visual feedback fully or partially.

Actuators and their driver circuits consume power. However, there is no need for the actuators to be continuously switched ON to implement the above mentioned use cases. Route guidance, for example, can be given in the form of a short signal burst when the user approaches a street crossing.

Features may be provided in an apparatus comprising a housing; and a haptic system comprising a plurality of haptic devices, where the haptic system is configured to generate a linear motion sensation in a direction at an exterior side of the housing to a user touching the housing, where the haptic devices do not move in the direction during the generated linear motion sensation.

Means may provide the direction as any one of a plurality of directions, where the means comprises a matrix of the haptic devices forming a majority of a rear surface of the exterior side of the housing. The haptic system may be configured to actuate at least two of the haptic devices in sequence. The haptic devices may comprise separate movable portions which are spaced from each other and mechanically substantially isolated from each others' motion. The haptic system may be configured to generate the linear motion sensation as an artificial sliding motion on the exterior side of the housing. The haptic system may be configured to vary frequency of movement of the haptic devices to provide the linear motion sensation. The haptic system may be configured to vary amplitude of movement of the haptic devices to provide the linear motion sensation. The haptic system may be configured to selectively actuate different groups of the haptic devices to provide different directions of the linear motion sensation. The direction may be a circular direction. The haptic system may be configured to generate the linear motion sensation as feedback to the user's use of a user interface of the apparatus. The haptic system may be configured to generate the linear motion sensation as feedback to a software program operation occurring with a processor of the apparatus. The haptic system may be configured to generate the linear motion sensation as feedback to provide navigational route guidance to a user.

A method may comprise sending signals to a plurality of separately movable haptic devices which are located at an exterior side of a housing as indicated by block 90 in FIG. 15; and actuating the haptic devices based upon the signals to generate a linear motion sensation to a user on the exterior side of the housing in a direction as indicated by block 92 in FIG. 15, where the haptic devices do not move in the direction to generate the linear motion sensation.

Actuating the haptic devices may comprise moving movable portions of the haptic devices in a second direction which is orthogonal to the direction in order to generate the linear motion sensation. Actuating the haptic devices to generate the linear motion sensation may comprise generating the motion as an artificial sliding motion on the exterior side of the housing. Actuating the haptic devices to generate the linear motion sensation may comprise varying frequency of movement of the haptic devices to provide the linear motion sensation. Actuating the haptic devices to generate the linear motion sensation may comprise varying amplitude of movement of the haptic devices to provide the linear motion sensation. Actuating the haptic devices to generate the linear motion sensation may comprise selectively actuate different groups of the haptic devices to provide different directions of the linear motion sensation. Actuating the haptic devices to generate the linear motion sensation may comprise moving different ones of the haptic devices at different times to form a circular pattern at the direction.

A program storage device readable by a machine, tangibly embodying a program of instructions executable by the machine for performing operations, may be provided (such as in the memory 24) where the operations comprise sending signals to a plurality of separately movable haptic devices which are located at an exterior side of a housing; and actuating the haptic devices based upon the signals to generate a linear motion sensation to a user on the exterior side of the housing in a direction, where the haptic devices do not move in the direction to generate the linear motion sensation.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising:
a housing; and
a haptic system comprising a plurality of haptic devices, where the haptic system is configured to generate a linear motion sensation in a direction at an exterior side of the housing to a user touching the housing, where the haptic devices do not move in the direction during the generated linear motion sensation.

2. An apparatus as in claim 1 comprising means for providing the direction as any one of a plurality of directions, where the means comprises a matrix of the haptic devices forming a majority of a rear surface of the exterior side of the housing.

3. An apparatus as in claim 1 where the haptic system is configured to actuate at least two of the haptic devices in sequence.

4. An apparatus as in claim 1 where the haptic devices comprise separate movable portions which are spaced from each other and mechanically substantially isolated from each others' motion.

5. An apparatus as in claim 1 where the haptic system is configured to generate the linear motion sensation as an artificial sliding motion on the exterior side of the housing.

6. An apparatus as in claim 1 where the haptic system is configured to vary frequency of movement of the haptic devices to provide the linear motion sensation.

7. An apparatus as in claim 1 where the haptic system is configured to vary amplitude of movement of the haptic devices to provide the linear motion sensation.

8. An apparatus as in claim 1 where the haptic system is configured to selectively actuate different groups of the haptic devices to provide different directions of the linear motion sensation.

9. An apparatus as in claim 1 where the direction is a circular direction.

10. An apparatus as in claim 1 where the haptic system is configured to generate the linear motion sensation as feedback to the user's use of a user interface of the apparatus.

11. An apparatus as in claim 1 where the haptic system is configured to generate the linear motion sensation as feedback to a software program operation occurring with a processor of the apparatus.

12. An apparatus as in claim 1 where the haptic system is configured to generate the linear motion sensation as feedback to provide navigational route guidance to a user.

13. A method comprising:
sending signals to a plurality of separately movable haptic devices which are located at an exterior side of a housing; and
actuating the haptic devices based upon the signals to generate a linear motion sensation to a user on the exterior side of the housing in a direction, where the haptic devices do not move in the direction to generate the linear motion sensation.

14. A method as in claim 13 where actuating the haptic devices comprises moving movable portions of the haptic devices in a second direction which is orthogonal to the direction in order to generate the linear motion sensation.

15. A method as in claim 13 where actuating the haptic devices to generate the linear motion sensation comprises generating the motion as an artificial sliding motion on the exterior side of the housing.

16. A method as in claim 13 where actuating the haptic devices to generate the linear motion sensation comprises varying frequency of movement of the haptic devices to provide the linear motion sensation.

17. A method as in claim 13 where actuating the haptic devices to generate the linear motion sensation comprises varying amplitude of movement of the haptic devices to provide the linear motion sensation.

18. A method as in claim 13 where actuating the haptic devices to generate the linear motion sensation comprises selectively actuate different groups of the haptic devices to provide different directions of the linear motion sensation.

19. A method as in claim 13 where actuating the haptic devices to generate the linear motion sensation comprises moving different ones of the haptic devices at different times to form a circular pattern at the direction.

20. A program storage device readable by a machine, tangibly embodying a program of instructions executable by the machine for performing operations, the operations comprising:
sending signals to a plurality of separately movable haptic devices which are located at an exterior side of a housing; and
actuating the haptic devices based upon the signals to generate a linear motion sensation to a user on the exterior side of the housing in a direction, where the haptic devices do not move in the direction to generate the linear motion sensation.
